(19) United States
(12) Patent Application Publication
(10) Pub. No.: US 2006/0112070 A1
(43) Pub. Date: May 25, 2006

(54) Interactive graphical interface for data manipulation and presentation

(76) Inventor: Oscar Alonso Ramos, Bogota (CO)

Correspondence Address: CENTRAL COAST PATENT AGENCY, PO BOX 187, AROMAS, CA, 95004, US

(21) Appl. No.: 11/076,463

(22) Filed: Mar. 8, 2005

Related U.S. Application Data
(60) Provisional application No. 60/630,798, filed on Nov. 24, 2004.

(51) Int. Cl. G06F 17/30

(52) U.S. Cl. 707/1

(57) ABSTRACT

A display for presenting dimensions and hierarchical levels of data has a plurality of branches, each branch representing a dimension in the data, a focus joining the plurality of branches, and one or more hierarchical regions posted along individual ones of the branches, the hierarchical regions each representing a level appropriate to the branch upon which it is posted. The branches and/or hierarchical regions may be labeled, and interactive uses are taught.

### CROSS-REFERENCE TO RELATED DOCUMENTS

This present invention claims priority to provisional patent application Ser. No. 60/630,798 filed on Nov. 21, 2004. The provisional application is included herein in its entirety at least by reference.

### BACKGROUND OF THE INVENTION

Online analytical processing (OLAP) is well-know in the art as computer processing that enables a user to selectively query, extract and view data from different points-of-view. OLAP server technology was developed to enable quick querying of the data commonly stored in data repositories, such as a Multidimensional Database (MDD). OLAP servers utilize special algorithms to store aggregated and consolidated data in a way that rapidly provides answers to multidimensional queries, allowing for essential on-line analysis of the data. Available OLAP client software connects users to OLAP servers through proprietary or open interfaces. Data is typically retrieved using user queries, and is then processed and presented to the user. Commonly in the art the user actually serves as the front-end interface to the stored data, through which investigation and analysis are performed.

OLAP can be used for data mining or for the discovery of previously un-discerned relationships between data entities. For example, a user might request that data be analyzed to display a spreadsheet showing all of a company's HD television products sold in California in the month of January, compare sales figures with those for the same products in September, and then see a comparison of other product sales in Florida in the same time period. To facilitate this kind of analysis, OLAP data is stored in data repositories structured to allow multiple dimensions to be referenced. Such a data repository typically considers each data attribute such as product, geographic sales region, and time period as a separate “dimension.”

There exist in the art a variety of ways for managing data from data sources. With the current technology available in the art the user is unable to generate a fast analysis and understanding of complex data. Moreover, OLAP technology lacks simple visual parameters, which could rapidly direct the user to main key-points and allow him or her to obtain inferences related to massive raw data.

Typically data trees and drop-down menus are provided to users to allow the user to view the hierarchy of data and data attributes. These data trees are commonly viewed in an ascending layout with main data attributes, branches and sub-branches. Every dimension of a data source represented by such a data tree is a new branch, and every level or hierarchy of the data is a sub-branch and so on. Selecting attributes on the data tree in this embodiment will open the tree to another ascending level of branches, sub-branches, measurements and attributes. For example, a user opening a branch of a tree labeled “state” would then be able to view a plurality of “cities” in a sub-branch belonging to that state.

The inventors of the present invention have identified a number of problems and unmet needs in the art of utilizing data trees and drop-down menus to view and retrieve information. One problem is that a user is presented with a mixture of concepts when interacting with the data tree, such as different dimensions, levels, attributes and measures of available data, which all operate autonomously in the tree structure. By viewing the tree, the user has no way of knowing what data is available as drop-down options for different attributes and branches. Visibility is lost, as the user has to open and close the branches to see what is available inside the data tree structure. The trees and menus are not clear for the user to understand because they are not a good representation of the structure of the data, and therefore it is not easy to manipulate and use.

In the present competitive business environment it is very important that employees have quick access to relevant and accurate information in their data repositories to make decisions. Although there are tools known in the art for generating information from data sources, the interfaces available are not user-friendly and efficient enough for end users to be able to generate their own reports in a timely manner. Most of the users access their information via predefined reports, generated by more highly trained technical staff.

The inventors of the present invention have discovered that a radial representation can manage and present many more dimensions graphically and simultaneously than is possible with presently-available systems. Accordingly, what is clearly needed in the art, and provided in the embodiments described in detail below, is a user friendly, multidimensional radial schema, interactive, graphical user interface. With such an interface a user, with minimal training and experience, could view the entire structure of a data source, and could generate reports and access information in an organized, efficient and timely manner with simple selection techniques, such as click, drag and drop interactions.

### FIELD OF THE INVENTION

This invention relates in general to data management systems managed by computers, and in particular, to software applications and systems for manipulating data in data repositories.

### SUMMARY OF THE INVENTION

In an embodiment of the present invention a display for presenting dimensions and hierarchical levels of data is provided, comprising a plurality of branches, each branch representing a dimension in the data, a focus joining the plurality of branches, and one or more hierarchical regions posted along individual ones of the branches, the hierarchical regions each representing a level appropriate to the branch upon which it is posted.

In some embodiments individual ones of the branches are labeled with the dimension they represent, and individual ones of the hierarchical regions are labeled with the level they represent. Also in some embodiments hierarchical regions take one or both of the forms of a point or a geometric region. In some cases the branches are straight-line in form, and the focus is a central focus, such that the branches joined at the focus present a radial graphic, while in other cases the branches are curvilinear in form.

In another aspect of the invention an interactive interface for manipulating data is provided, comprising a plurality of branches, each branch representing a dimension in the data, a focus joining the plurality of branches, and one or more hierarchical regions posted along individual ones of the branches, the hierarchical regions each representing a level appropriate to the branch upon which it is posted. The data may be accessed or manipulated by selecting branches or hierarchical regions from the radial graphic.

In some embodiments of the interactive interface individual ones of the branches are labeled with the dimension they represent, and individual ones of the hierarchical regions are labeled with the level they represent. Also in some embodiments the hierarchical regions take one or both of the forms of a point or a geometric region. In some cases the branches are straight-line in form, and the focus is a central focus, such that the branches joined at the focus present a radial graphic. In other cases the branches are curvilinear in form.

In yet another aspect a system for accessing or manipulating data is provided, comprising an interactive display having a plurality of branches each representing a dimension of the data, a focus joining the plurality of branches, and one or more hierarchical regions posted along individual ones of the branches, the hierarchical regions each representing a level appropriate to the branch upon which it is posted, and an interactive window for report generation, enabling a user to select individual branches or hierarchical regions, and to use the selections in report generation.

In one embodiment of the system the window for report generation comprises one or more fields associated with report characteristics, and the user is enabled to select branches or hierarchical levels from the display and to place them into individual ones of the fields. In another embodiment the system further comprises a window wherein a report is presented, the report prepared from information from the data selected and manipulated according to the fields populated by the user from the radial graphic.

In some embodiments the report is a tabular report, and in other embodiments the report is a graphical report. In some embodiments the system has stored reports which may be opened and altered to make new reports. In some embodiments of the system individual ones of the hierarchical regions posted along the branches include indicia indicating whether the associated level is used in a report.

In still another aspect of the invention a method for presenting dimensions and hierarchical levels of data is provided, comprising the steps of (a) representing dimensions in the data as a plurality of branches; (b) joining the plurality of branches at a focus; and (c) posting one or more hierarchical regions along individual ones of the branches, the hierarchical regions each representing a level appropriate to the branch upon which it is posted.

In some embodiments of the method individual ones of the branches are labeled with the dimension they represent, and individual ones of the hierarchical regions are labeled with the level they represent. Also in some embodiments the hierarchical regions take one or both of the forms of a point or a geometric region. The branches are straight-line in form in some cases, and the focus is a central focus, such that the branches joined at the focus present a radial graphic. In some other cases the branches are curvilinear in form.

In yet another aspect of the invention a method for accessing or manipulating data is provided, comprising the steps of: (a) representing dimensions in the data as a plurality of branches in a display; (b) joining the plurality of branches at a focus; (c) posting one or more hierarchical regions along individual ones of the branches, the hierarchical regions each representing a level appropriate to the branch upon which it is posted; and (d) rendering at least portions of the branches or hierarchical regions as interactive regions wherein the data may be accessed or manipulated by selecting individual ones of the interactive regions.

In some embodiments individual ones of the branches are labeled with the dimension they represent, and individual ones of the hierarchical regions are labeled with the level they represent. Also in some embodiments the hierarchical regions take one or both of the forms of a point or a geometric region.

In some cases the branches are straight-line in form, and the focus is a central focus, such that the branches joined at the focus present a radial graphic. In some other cases the branches are curvilinear in form.

In still another embodiment a method for accessing or manipulating data is provided, comprising the steps of (a) providing an interactive display having a plurality of branches each representing a dimension of the data, a focus joining the plurality of branches, and one or more hierarchical regions posted along individual ones of the branches, the hierarchical regions each representing a level appropriate to the branch upon which it is posted; and (b) associating an interactive window for report generation with the interactive display, and enabling a user to select individual branches or hierarchical regions, and to use the selections in report generation.

In some embodiments of this method the window for report generation comprises one or more fields associated with report characteristics, and the user is enabled to select branches or hierarchical levels from the display and to place them into individual ones of the fields. Also in some embodiments the method further comprises a window wherein a report is presented, the report prepared from information from the data selected and manipulated according to the fields populated by the user from the radial graphic. In some cases the report is a tabular report, and in other cases a graphical report.

In some embodiments the system has stored reports which may be opened and altered to make new reports. Also in some embodiments individual ones of the hierarchical regions posted along the branches include indicia indicating whether the associated level is used in a report.

### BRIEF DESCRIPTION OF THE DRAWING FIGURES

FIG. 1a is a representation of a 3D interface as known in the art.

FIG. 1b is a representation of a data tree as known in the art.

FIG. 2a is a radial graphic representation of an interface to a data source including branches, reflecting an embodiment of the present invention.

FIG. 2b through 2e illustrates alternative ways branches may be depicted.

FIG. 3a is a representation of a report interface according to an embodiment of the present invention.

FIG. 3b illustrates several graphics representing dimensions data in an embodiment of the present invention.

FIG. 4 illustrates a Report Design interface according to an embodiment of the present invention.

FIG. 5 illustrates a Format design interface according to an embodiment of the present invention.

FIG. 6 illustrates a new report generated according to an embodiment of the present invention.

FIG. 7 is a process flow diagram for a method for generating reports with a system according to an embodiment of the present invention.

### DESCRIPTION OF THE PREFERRED EMBODIMENTS

Multidimensionality is a somewhat simple concept for technically-inclined individuals, such as engineers and scientists, but the concept is not so simple for the common end user. This type of technology is cumbersome for the end user to grasp in it's entirety as the connections, dimensions and such are highly technical and often expand into multiple hierarchies too difficult to be easily understood.

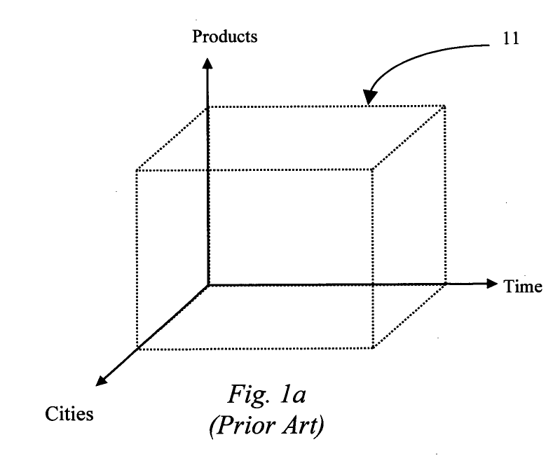

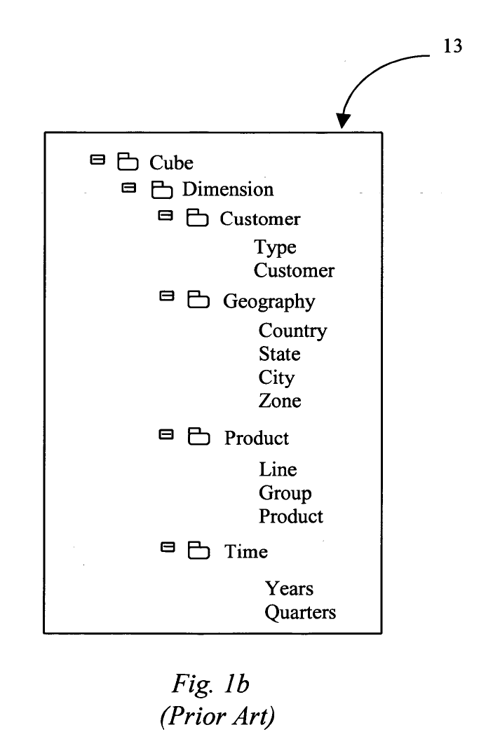

FIG. 1a illustrates a data cube 11 representing the dimensions of data available to a user from a data source as known in the art. The data source can be of any of many forms, such as a multidimensional database, a flat file, and XML file, or some other format. The cube depicts the three dimensions of the data source. Each dimension is separately labeled in this particular example as products, time and cities. An advantage of this structure is in the underlying linking that connects the dimensions. The connection point is the joining of the three dimensions. This linking expands the analytical capability of the data, since it allows for a meaningful representation of more than two dimensions, and information which lies in the relationship between the dimensions. The dimensions can be compared for example, to what products were sold in what time period in a particular city. This Cartesian representation of the data base is quite useful for three dimensions, but does not adequately represent a situation when more than three dimensions are needed.

FIG. 1b illustrates a data tree structure 13 commonly used in the current art to access information in a data source. In the tree representation shown every dimension is a new branch and every level or hierarchy is a sub-branch. When the user clicks on a sub-branch, such as the branch labeled “customer”, for example, a drop-down menu appears with additional levels of data labeled “type” and “customer”. If these levels are selected by the user then additional attribute or measure data may appear, for example, retail, wholesale or sales figures of customers under the “type” label or individual names of customers under the “customer” level.

Report generation can be very cumbersome using the tree structure. Presentation of multidimensional data usually requires several two- or three-dimensional graphs, which are complicated and cumbersome for proper analysis and presentation of the connection between different dimensions.

The inventors have realized that this is a serious problem in accessing and generating reports from a multi-dimensional data source. Users may be overwhelmed when presented with a mixture of concepts (dimensions, levels, attributes, measures), and the concepts all work differently. By viewing a data tree the user has no intuitive way of knowing which dimensions or leaves can be dropped down and where. Visibility may be lost, as the user has to open and close the branches to see what is inside.

The present inventors have solved this problem by developing a new interactive way to deal with a data source. This new and unique concept of an interactive graphical interface is termed Radial Viewer by the inventors, and is designed to provide outstanding data analysis, reporting, and data mining capabilities to end-users. The term radial viewer is used frequently in the following descriptions except where to do so might cause confusion.

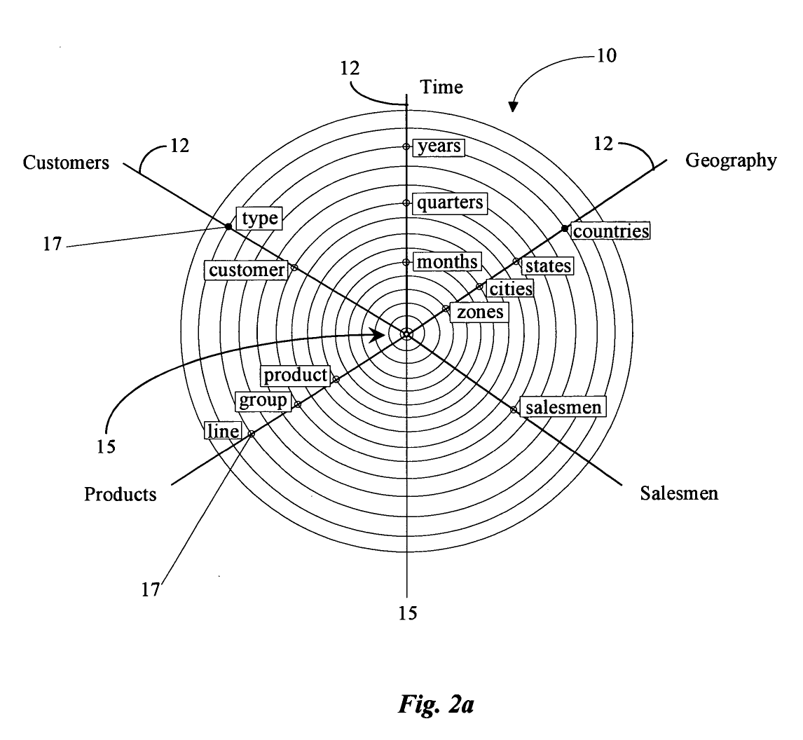

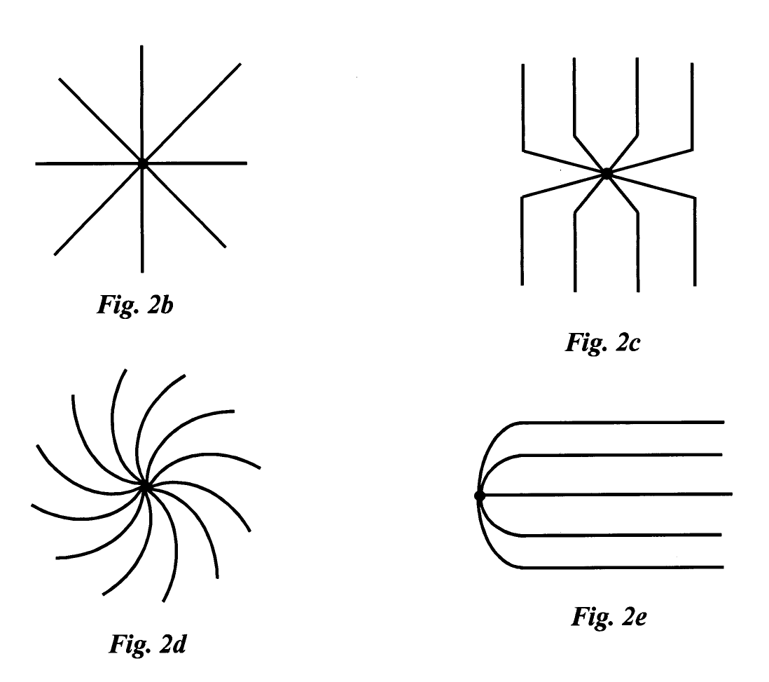

FIG. 2a illustrates the Radial Viewer concept in a preferred embodiment of the present invention wherein the multidimensional model is represented using a radial graphic 10 which may be displayed on a video display unit (VDU). Graphic 10 is part of Radial Viewer's interactive graphical interface for enabling a user to view the multiple variables and dimensions in the structure of available data essentially simultaneously. In this novel representation all of the branches, such as branches 12, connect to a central focus 15. Each branch in this unique radial concept may be equated or related to a data cube as described in FIG. 1. The various branches (variables) are represented in the example of FIG. 2 as Customers, Time, Geography, Salesmen and Product. Different hierarchies to group data related within the same branch are represented as points, such as points 17, on the branches, with the points labeled, for example, on the branch for time, as months, quarters, and years. Clearly more granular points could be enabled and labeled, such as weeks, days, hours, and so on, for the time variable, and zones, cities, states and countries for the geography variable. The representations here are meant to be exemplary.

In some representations some or all of the points might not be labeled. In this instance a mouse over, for example, might show the labels identifying data that is part of a particular dimension.

In this particular embodiment, at any point in time, label representations that are available to be used for report generation may have a different representation than some other points. For example, the point labeled “customers” shows as an empty circle (considered an “on light”). Then those points that may not be used for report generation may be shown as a filled-in circle (see “type”), considered an “off-light”. The result is that the user gets a fast and efficient view of all the variables he or she may use (“on light”) and the variables previously selected or not available for the report generation (“off light”). The user may then easily understand, by viewing the radial graphic, how the data is organized without being aware of concepts like “dimensions” or “hierarchies”, or by extensive studying or training. In the new representation branches and their contents are interconnected at the central focus 15, which represents the inner linking of all branches having various dimensions.

Although both the data tree and the unique radial graphic represent perhaps similar concepts, the radial graphic is much easier to understand and to use than the tree view, where a user must go through a laborious process of opening, closing, scrolling up and down, and sometimes guessing where desired data may be located. Using the radial graphic representation, data dimensions are easily seen and manipulated for quick and easy report generation as described in more detail below.

The inventors believe that the unique radial graphic in embodiments of the present invention can hold many more dimensions, attributes and hierarchical levels simultaneously viewable and selectable by the user than can conventional systems. Because the radial graphic may be concentric, wherein all variables are represented as being inter-connected in the central focus 15, users find it natural to view and cross attributes and measures as in “products” and “years” to produce reports containing information based on specific products sold in the year 2004, for example. The central focus 15 represents a point wherein all data dimensions are connected, related and compared for report generation.

One of the important advantages of the radial graphic representation is in the underlying linking that connects the dimensions and points therein. This unique linking advantageously expands the analytical capability of the data, since it allows for a meaningful representation of more than two dimensions, and information which lies in the relationship between the dimensions. The user also is able to visually grasp the structure and linkage (intuitive) which greatly enhances the understanding of the entire data structure and report generation capabilities available to the user.

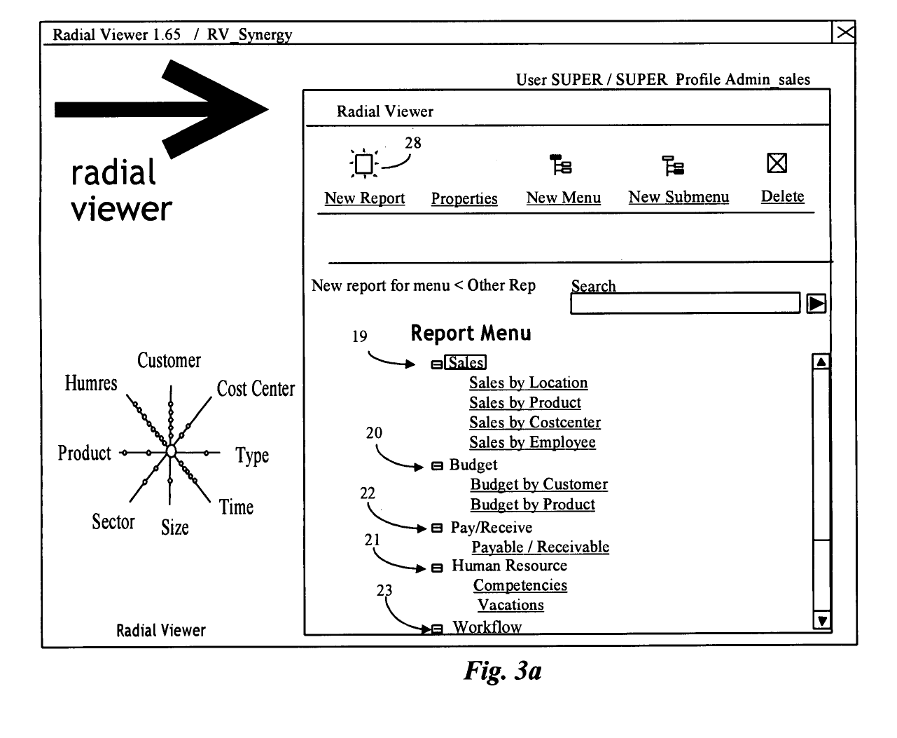

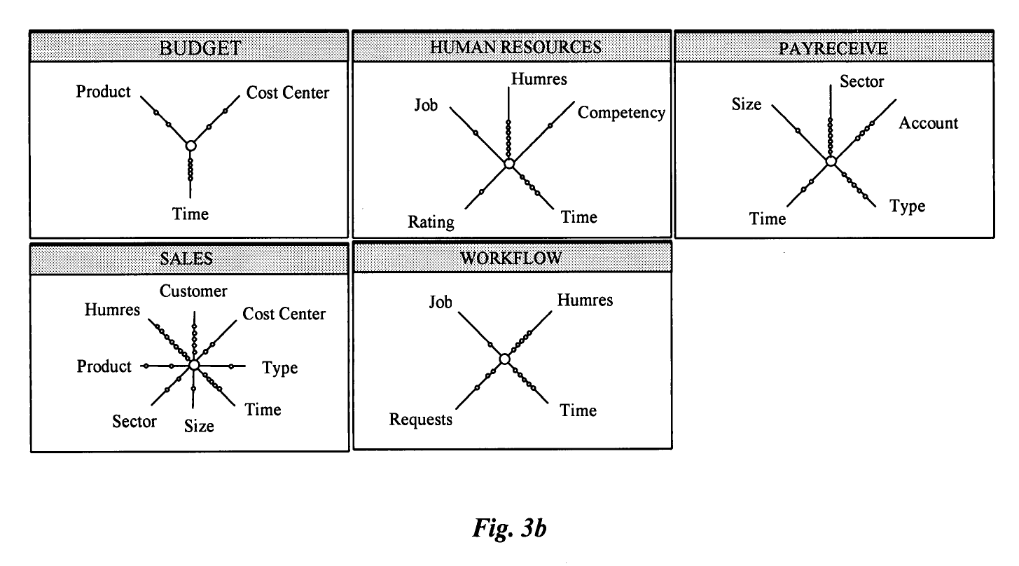

FIG. 3a illustrates a report menu window of the Radial Viewer as presented on a VDU in an embodiment of the invention. In this embodiment the user has previously logged on in a conventional manner, such as by entering a user name and password pair. The user may select a data source, for example “RV_Siscorp”, when logging on. In this example all of the previously created reports representing data relationships in the data source are listed under “Report Menu” as Sales 19, Budget 20, Pay/Receive 22, Human Resources 21 and Workflow 23.

There may be an option to add reports to the New Report menu from an “Other Reports” entry (not shown) in the list. When selected, the user may be offered a pop up window (not shown) to name the report to be added. The user may then select the added report and place it onto any other folder 19-23, such as by a drag-and-drop technique.

FIG. 3b demonstrates a variety of radial graphics representing available data categories, some of them listed in FIG. 3a. Here a different data entity represents different data aspects of the organization “RV_SISCORP”. The radial graphic of the different entities may be seen individually, as shown, or the entire “RV_SISCORP” data source might be represented in one or more radial graphics. The number of radial graphics representing particular dimensions of a data source are not limiting to the invention. There could be a large number, or just a few, or perhaps even just one.

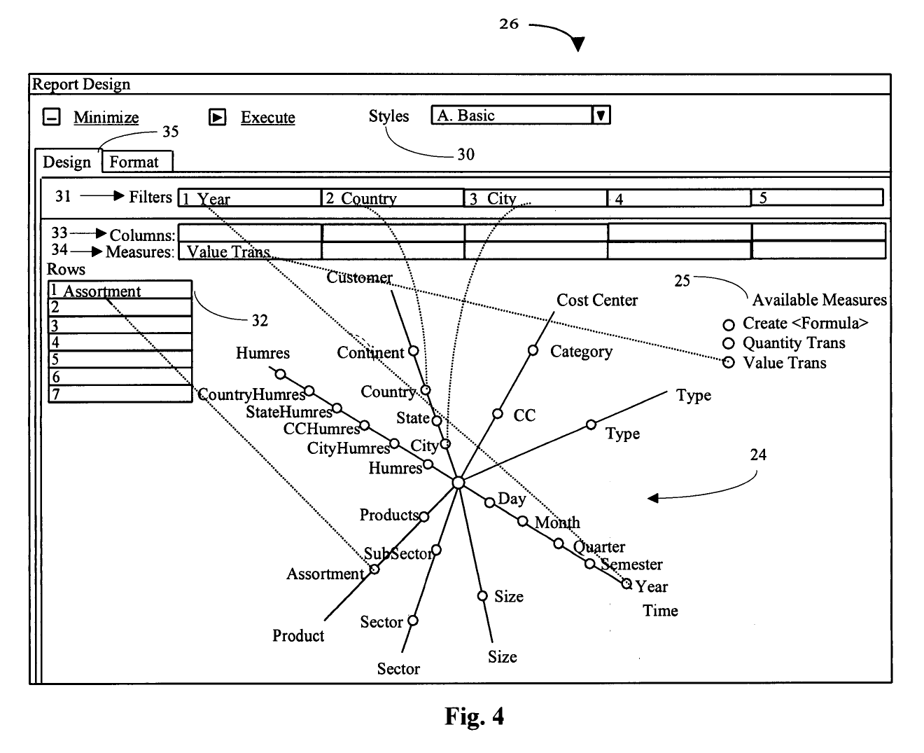

To create a report using this unique system the user may, for example, select the “New Report” option 28 shown in FIG. 3a. The user may then be prompted with a display of radial graphics as shown, for example, in FIG. 3b, and the user may select one of the radial graphics. The user may then be presented with a window to give a name to the report (not shown). A report design window pops up, as seen in FIG. 4 and described more fully below. The user interacts with the many functions presented by the report design window to create the report. The user may then save the report and go back to the main window. In the main window the user can include the new report in the menu structure and publish it to other users. Further the user can create entries in the menu structure.

FIG. 4 illustrates a New Report interactive window 26 of the Radial Viewer enabling a user to customize design of a new report or redesign of a previously-created report by manipulating the multidimensional radial graphic 24. The user may initiate selection techniques, such as iconic drag-and-drop procedures, wherein the user may select items from the radial graphic 24 to enter into Filters 31, Rows 32 or Columns 33. From Available Measures list 25 the user may select and enter to Filters 31 or Measures 34.

As seen in the Report Design window, represented by dotted directional lines, the user has selected variables Year, Country and City from the multidimensional radial graphic and dropped them into the Filters field 31. The user also selects item “Assortment” from the radial graphical and drops it into the field position number one under Rows 32. The user then selects the item Value Trans from an Available Measures list 25 which is dropped in a field next to Measures 34. The report design choices shown in FIG. 4 are exemplary and are not limiting to the scope of the invention as there may be several more or fewer design choices than the ones described herein.

The user may also select a style 30 for a report from an associated pull down menu. This option can be changed either before, or after report generation. The Execute selection generates the report after the design function is completed as described. When the Report Design window is minimized the user may have the option of further defining filters with numeric values or restrictions, such as greater than $1,000.00, for example. Also, when the Report Design window is minimized the full report can be viewed, stored or printed.

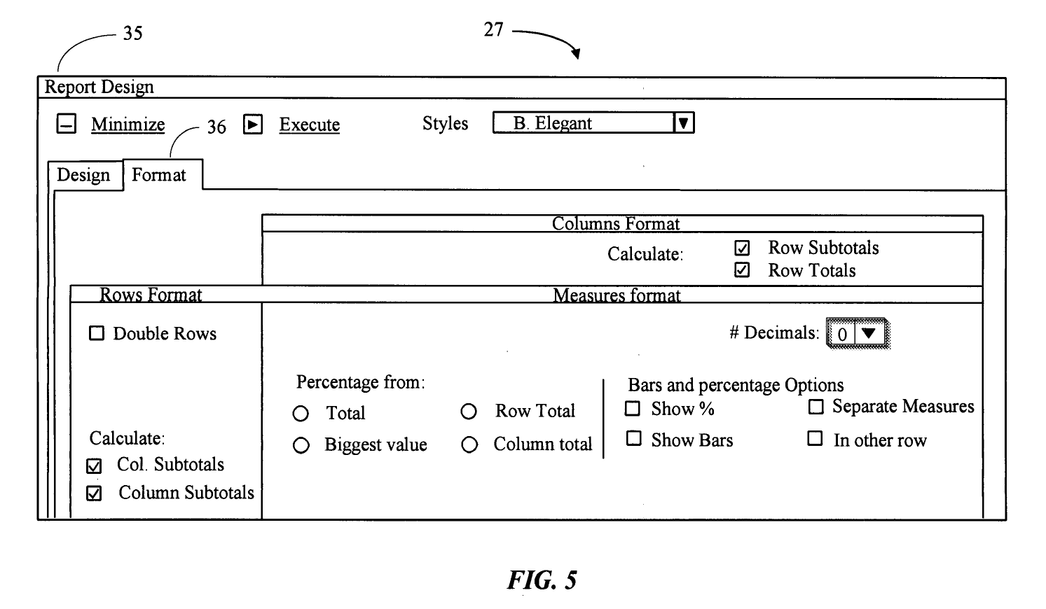

FIG. 5 shows a format version 27 of the Report Design window with a format design tab 36 selected. The format screen is primarily to initiate or adjust calculation and measure settings. In this example we see portions of the screen designated for Columns format, Rows format and Measures format. The user has selected boxes for Row Subtotals, Row Totals, Col. Subtotals and Column totals. Percentage From and Bars and Percentage options are also provided.

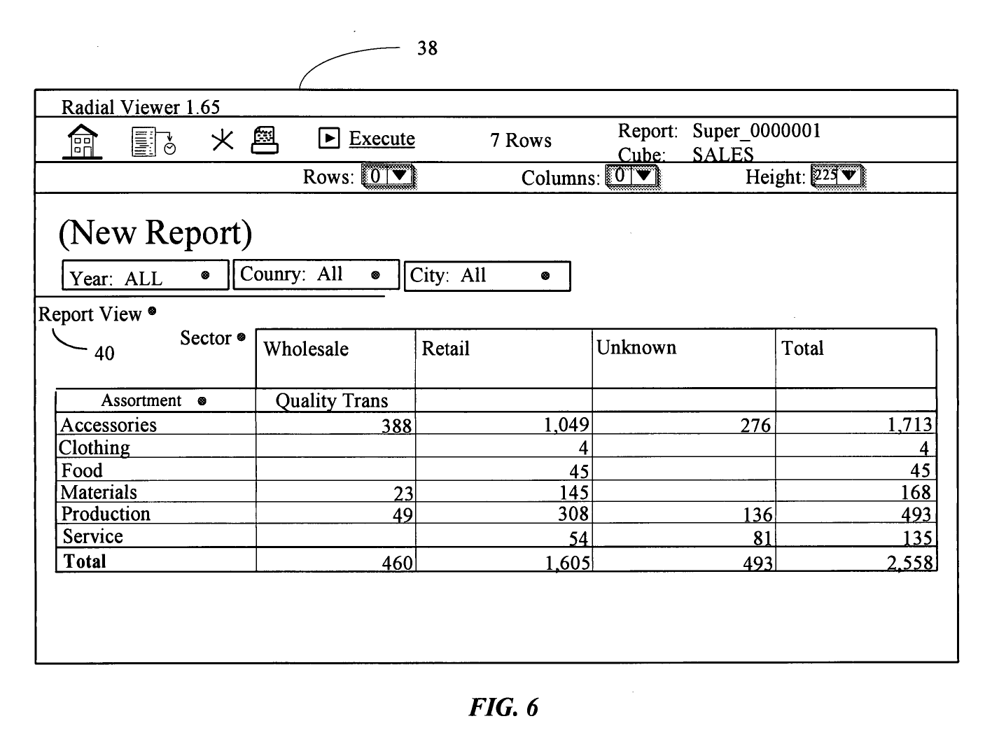

FIG. 6 is an example of a New Report window 38 showing the report generated from the manipulations with the Design Report window as described above. Selections are provided at the top of the window for further manipulation of the new report. Report results can be sorted by the user clicking on the small buttons next to the heading descriptions Assortment and Sector. Sorting may be done in many ways of which Alphabetical order, Ascending order and Descending order are shown. The Ascending and Descending options use the numeric values for Total for sorting criteria.

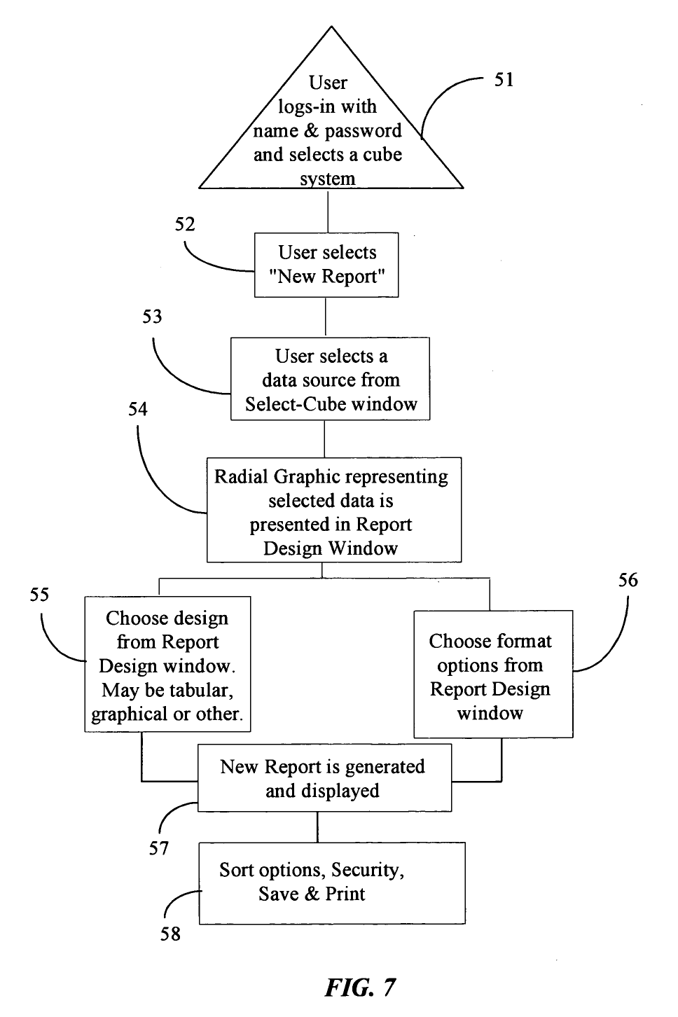

FIG. 7 is a process flow diagram illustrating a method for generating reports with the Radial Viewer. In step 51 a user logs in by providing a name and password. A system is then selected which represents a data source. Next, the user selects New Report in step 52 from a selection of options Properties, New Menu, New Submenu and Delete, as shown in FIG. 3a. In step 54 the user selects a portion of the data source available for report generation. In FIG. 3a Sales is selected and a radial graphic representation may be shown in FIG. 4 as part of the Report Design window. The user may then select from a plurality of Report Design functions in step 55 by selecting the Design tab.

As shown in FIG. 4 the user has many selections for Filters, Measures Columns and Rows. A user may simply click on and select, by such as a drag-and-drop technique, an item directly from the radial graphic representation and drop it into one of the fields available. The user also may format the new report in step 56 by selecting Format tab 36 as shown in FIG. 5. Here the user may select from format options shown as Columns, Measures and Rows. The New Report is then generated in step 57 and displayed in table form in the New Report window 3 8 as shown in FIG. 6. At this point the user may sort columns and rows displayed in Alphabetical, Ascending or Descending order, for example. Next, the user selects different options for the report in step 58, and may save and print.

The inventors have provided in Radial Viewer a live (real time) feature to generate reports. With this feature, every time a user retrieves a saved report the data is automatically retrieved from the main data source and the report is updated. The user, when creating the report, also has the ability to select security options, such as to who may have access to the report.

The inventors believe that the Radial representation delivers advantages for report generation over what is known in the art, partly because of many user-friendlier interaction and higher visibility. Technical personnel may need as little as two hours to be fully trained as to the programming options and architecture of the Radial Viewer. End-users actually performing report generation may require as little as 10 minutes to 1 hour to become adept at generating reports.

Other advantages of he Radial Viewer are, that in various embodiments, the multidimensional relationships are presented graphically, users understand it without explanations, and can make reports using simple selection techniques, such as click, drag and drop functions.

Also in embodiments there are typically fewer than ten options in every screen. Pull-down menus are limited and usually there are no right-click hideouts where needed data or report options cannot be easily seen or accessed. Users are presented with relatively few, intuitive and visible options. Also, displays and printouts of reports made from Radial Viewer fit the screen and print perfectly. No extensive formatting is required. Finally, the interface is very attractive and user friendly, reports are attractive and clean which make the program more intuitive and a pleasure to use for anyone.

The above examples and description have been provided only for the purpose of illustration, and are not intended to limit the invention in any way. As will be appreciated by the skilled person, the invention can be carried out in a great variety of ways, employing more than one technique from those described above, all without departing from the spirit and scope of the invention. The invention is therefore limited only by the claims that follow.

What is claimed is:

1. A display for presenting dimensions and hierarchical levels of data, comprising:
a plurality of branches, each branch representing a dimension in the data;
a focus joining the plurality of branches; and
one or more hierarchical regions posted along individual ones of the branches, the hierarchical regions each representing a level appropriate to the branch upon which it is posted.

2. The display of claim 1 wherein individual ones of the branches are labeled with the dimension they represent, and individual ones of the hierarchical regions are labeled with the level they represent.

3. The display of claim 1 wherein the hierarchical regions take one or both of the forms of a point or a geometric region.

4. The display of claim 1 wherein the branches are straight-line in form and the focus is a central focus, such that the branches joined at the focus present a radial graphic.

5. The display of claim 1 wherein the branches are curvilinear in form.

6. An interactive interface for manipulating data, comprising:
a plurality of branches, each branch representing a dimension in the data;
a focus joining the plurality of branches; and
one or more hierarchical regions posted along individual ones of the branches, the hierarchical regions each representing a level appropriate to the branch upon which it is posted;
wherein the data may be accessed or manipulated by selecting branches or hierarchical regions from the radial graphic.

7. The interactive interface of claim 6 wherein individual ones of the branches are labeled with the dimension they represent, and individual ones of the hierarchical regions are labeled with the level they represent.

8. The interactive interface of claim 6 wherein the hierarchical regions take one or both of the forms of a point or a geometric region.

9. The interactive interface of claim 6 wherein the branches are straight-line in form and the focus is a central focus, such that the branches joined at the focus present a radial graphic.

10. The interactive interface of claim 6 wherein the branches are curvilinear in form.

11. A system for accessing or manipulating data comprising:
an interactive display having a plurality of branches each representing a dimension of the data, a focus joining the plurality of branches, and one or more hierarchical regions posted along individual ones of the branches, the hierarchical regions each representing a level appropriate to the branch upon which it is posted; and
an interactive window for report generation, enabling a user to select individual branches or hierarchical regions, and to use the selections in report generation.

12. The system of claim 11 wherein the window for report generation comprises one or more fields associated with report characteristics, and the user is enabled to select branches or hierarchical levels from the display and to place them into individual ones of the fields.

13. The system of claim 12 further comprising a window wherein a report is presented, the report prepared from information from the data selected and manipulated according to the fields populated by the user from the radial graphic.

14. The system of claim 13 wherein the report is a tabular report.

15. The system of claim 13 wherein the report is a graphical report.

16. The system of claim 11 wherein the system has stored reports which may be opened and altered to make new reports.

17. The system of claim 11 wherein individual ones of the hierarchical regions posted along the branches include indicia indicating whether the associated level is used in a report.

18. A method for presenting dimensions and hierarchical levels of data, comprising the steps of:
(a) representing dimensions in the data as a plurality of branches;
(b) joining the plurality of branches at a focus; and
(c) posting one or more hierarchical regions along individual ones of the branches, the hierarchical regions each representing a level appropriate to the branch upon which it is posted.

19. The method of claim 18 wherein individual ones of the branches are labeled with the dimension they represent, and individual ones of the hierarchical regions are labeled with the level they represent.

20. The method of claim 18 wherein the hierarchical regions take one or both of the forms of a point or a geometric region.

21. The method of claim 18 wherein the branches are straight-line in form and the focus is a central focus, such that the branches joined at the focus present a radial graphic.

22. The method of claim 18 wherein the branches are curvilinear in form.

23. A method for accessing or manipulating data, comprising the steps of:
(a) representing dimensions in the data as a plurality of branches in a display;
(b) joining the plurality of branches at a focus;
(c) posting one or more hierarchical regions along individual ones of the branches, the hierarchical regions each representing a level appropriate to the branch upon which it is posted; and
(d) rendering at least portions of the branches or hierarchical regions as interactive regions wherein the data may be accessed or manipulated by selecting individual ones of the interactive regions.

24. The method of claim 23 wherein individual ones of the branches are labeled with the dimension they represent, and individual ones of the hierarchical regions are labeled with the level they represent.

25. The method of claim 23 wherein the hierarchical regions take one or both of the forms of a point or a geometric region.

26. The method of claim 23 wherein the branches are straight-line in form and the focus is a central focus, such that the branches joined at the focus present a radial graphic.

27. The method of claim 23 wherein the branches are curvilinear in form.

28. A method for accessing or manipulating data, comprising the steps of:
(a) providing an interactive display having a plurality of branches each representing a dimension of the data, a focus joining the plurality of branches, and one or more hierarchical regions posted along individual ones of the branches, the hierarchical regions each representing a level appropriate to the branch upon which it is posted; and
(b) associating an interactive window for report generation with the interactive display, and enabling a user to select individual branches or hierarchical regions, and to use the selections in report generation.

29. The method of claim 28 wherein the window for report generation comprises one or more fields associated with report characteristics, and the user is enabled to select branches or hierarchical levels from the display and to place them into individual ones of the fields.

30. The method of claim 28 further comprising a window wherein a report is presented, the report prepared from information from the data selected and manipulated according to the fields populated by the user from the radial graphic.

31. The method of claim 30 wherein the report is a tabular report.

32. The method of claim 30 wherein the report is a graphical report.

33. The method of claim 28 wherein the system has stored reports which may be opened and altered to make new reports.

34. The method of claim 28 wherein individual ones of the hierarchical regions posted along the branches include indicia indicating whether the associated level is used in a report.
